(19) United States
(12) Patent Application Publication
(10) Pub. No.: US 2018/0127953 A1
(43) Pub. Date: May 10, 2018

(54) Drain Water Receiver

(71) Applicant: Apex Stainless Works Inc., Petaluma, CA (US)

(72) Inventor: Lars Noren, Petaluma, CA (US)

(73) Assignee: Apex Stainless Works Inc., Petaluma, CA (US)

(21) Appl. No.: 15/346,730

(22) Filed: Nov. 9, 2016

(51) Int. Cl. E03B 1/04; B01D 29/56; B01D 35/26; B01D 29/92; B01D 29/60; B01D 41/00; B01D 35/027; C02F 1/00; A47L 15/42

(52) U.S. Cl. CPC E03B 1/041; B01D 29/56; B01D 35/26; B01D 29/925; B01D 29/605; B01D 41/00; C02F 2103/002; C02F 1/008; C02F 1/004; A47L 15/4291; A47L 15/4225; E03B 2001/045; B01D 35/027

(57) ABSTRACT

The present invention provides a new approach to decreasing water use, energy consumption, chemical use and sewage expense in commercial kitchen operations by reusing drain water and recovering the heat energy, thereby reducing operation costs. The invention, however, is not limited to kitchen operations, it could be applied to other operations that produce greywater and could benefit from reusing water and resources.

### BACKGROUND

Commercial warewashers and three-compartment sinks are widely used nationally and internationally. The equipment is used by many different industries including the food service, medical, and laboratory industries. The use of water by commercial warewashers and three-compartment sinks is for washing, rinsing, and sanitizing kitchen and dining wares. The amount of water used in this process varies with the type, model, and method of sanitation. On average, the commercial warewashers use as much as 100 to 300 gallons of potable water per hour. The three-compartment tanks use, on average, 840 gallons of water per day. The heat energy consumption is notable. The first step in both low and high temp warewashing is to heat the fill water entering the machine from ground temperature to 120°-140° F. (49°-60° C.). Although chemical machines do not require additional water heating, they do require added chemicals to sanitize. With high temp machines, the power wash tank and/or power rinse tank(s) water is internally heated from 150° F. (66° C.) to 175° F. (79° C.) by heating units in the warewasher. Additionally, on high temp machines, there is an additional independent piece of equipment commonly referred to as a hot water booster heater to heat additional incoming potable water from 180°-195° F. (82°-91° C.) for the final rinse. This is just one example. Heat energy is consumed heating water in other scullery operations. The greywater produced by the warewashers, three-compartment sinks and other sources may be reused. Prior attempts to reuse the greywater have failed to make a material impact. The current practice is to dispose of the greywater down the drain. The costs associated with the greywater include the cost of the water, heat energy, detergent, other chemicals and disposal. Effectively reusing greywater including the variety of resources in the greywater would result in huge savings and have a definite environmental impact.

The International Plumbing Code, 2006, paragraph 701.7 reads, “Wastewater when discharged into the building drainage system shall be at a temperature not higher than 140° F. (60° C.). When higher temperatures exist, approved cooling methods shall be provided.” Most commercial warewashers implement a three-step process. If water at or above 140 degrees Fahrenheit is drained from equipment with steamers and warewashers, a drain-water-tempering kit must be installed in the equipment to ensure the water does not soften the plastic piping. The problem with the current method of tempering is that it uses potable water to cool the greywater to the appropriate temperature. This is an additional waste of potable water, and heat energy. The heat in the sanitation greywater could be captured and reused. The greywater from the sanitation cycle could be reused. Reusing these resources would provide huge savings and conservation. Currently, no system exists that functions well enough to make a widespread impact.

Warewashers and three-compartment sinks are not the only sources of greywater in commercial food service facilities.

The first scullery step in most restaurants and food service establishments is to scrap the kitchen and dining wares. The scraps may go into a garbage can, sink basket, scrap accumulator, garbage disposer, pulper, dehydrator, digester and in some cases by way of a scrapping trough. Scrapping troughs vary in widths and lengths and operate optimally with high flow rates of recirculated water and allow two-hand scrapping. Scrapping troughs with disposers incorporated in them typically have to be plumbed with additional potable water lines introduced for flushing from the opposite end of the trough from the disposer due to the inability of a disposer to recirculate water. This water is typically not recirculated or reused causing a facility to suffer increased water usage and sewage expense. The ideal temperature for water in the scraping system is 105-115° F. (40-46° C.). Currently, potable water is used and heated in commercial warewashers for the scraping process and then disposed of. This is a waste of water because potable water is not necessary for scrapping. If 105-115° F. (40-46° C.) greywater could be utilized in these systems there would be considerable savings and conservation.

A commercial warewasher not only uses water in the scrapping, washing, and sanitation cycles, there are other hidden water costs. There is the water used with chemical dispensers, water from other equipment commonly found on commercial dish machines, such as cold water tempering options commonly found on the drains to temper drain water, and on un-heated scrap tanks receiving spent final rinse water to heat these tanks, and water used to wash the inside of the dish machines during routine cleaning. A commercial operation could save millions of gallons of water by capturing and reusing all of the drain water from a commercial warewasher.

One reason scullery greywater is not currently being reused from commercial warewashers, three-compartment sinks, scrapers and other water consuming apparatuses is that commercial facilities are unique in design and manner of use. Greywater reusing mechanisms have been attempted in scullery operations, but failed for lack of efficiency, resilience, scalability, and/or configurability, such that an effective universal solution has not been achieved. Often the attempted solutions are designed to fit with one brand, type, or model of kitchen apparatus. They are not self-contained or amenable to the needs of the facility design.

### SUMMARY

The present invention provides a new approach to decreasing water usage, energy consumption and chemical use and sewage expense in commercial scullery operations by reusing the drain water and/or recovering the heat energy from a scullery operation, thereby reducing operation costs. The invention, however, is not limited to scullery operations, it could be applied to other operations that produce greywater and could benefit from reusing water and resources. Scullery operations is used interchangeably with commercial kitchen operations.

The invention may be used to a particular advantage in the context of a scullery operation by reusing the drain water and/or heat energy from a commercial warewasher and/or three-compartment sink and reusing it to operate a disposer, pulper, scrap accumulator, scrap collector, or scrap trough, thereby reducing the amount of potable water and heat energy used by the amount needed to operate the disposal, pulper, scrap accumulator or scrap trough, thereby reducing operations costs and meeting mandates to reduce water usage.

An embodiment of the invention is specifically designed to accommodate all sizes of dish machines from the smallest to the largest, regardless of manufacturer. The invention is further designed to pass through all unused drain water during operation (via pumping and overflow system) or during non-use (via overflow system only) without overflowing onto the floor. The invention truly has a flow-through design.

In one embodiment of the invention the drain water receiver has the pumping capacity to pump more water than a given warewasher can consume on a per-minute and/or per-hour basis. Commercial warewasher water “consumption” is based on NSF Standard 3 testing criteria. NSF consumption ratings measure the final rinse water used for sanitization only. Further, the drain water receiver's pumping capacity exceeds the volume of final rinse water consumed on a continual operating basis. In addition, the drain water receiver's pumping systems is designed to handle the extra fill and make-up fill water dish machines commonly use during operation but is not published or advertised to the customers and is not recognized in the NSF testing per se. Pumping capacity and overflow capacity of the invention is primary to holding capacity.

A manifestation of the invention comprises a receiving tank that is scalable in dimensions and its component parts (as described subsequently) are configurable to fit in a wide variety of commercial settings, one or more inlet ports on the receiving tank are configurable to receive drain water from a warewasher or other system, preferably the drain water is gravity fed to the receiving tank, one or more overflow ports on the receiving tank being at a height lower than the inlet ports, that function in conjunction with the inlet port to prevent overflow or back up into a warewasher or other system, at least one pump configured to optimally transfer the drain water out of the receiving tank for reuse, an intake system allowing the pump to operate at minimal water levels, a sensor for powering the pump in response to the water level in the receiving tank, controls may be implemented to receive data from the sensors for operation of the pump at a remote location, a system may be implemented to prolong the life of the pump by maintaining continuous operation of the pump whether or not there is demand for the greywater, a filtering system may comprise a primary screened box to pre-screen drain water entering the inlet port and a secondary screened box situated to prevent particulate matter from clogging the pump, the drain water receiver may function to temper drain water that is over 140° F., at least one heat exchanger may be configured to capture or release energy from the drain water if there is a need for this function, a baffled system to prevent sloshing.

A principal object of the invention is to provide higher efficiency, maximum operational reliability, lower operating costs, and reduce wastewater for scullery operations or other analogous operations.

Other objects will become apparent from the following description, in which reference is made to the accompanying drawings.

### BRIEF DESCRIPTION OF THE DRAWINGS

FIG. 1 is a schematic front elevational representation of a preferred form of the drain water receiver.

FIG. 2 is a schematic elevational representation of the right side of a preferred form of the drain water receiver.

FIG. 3 is a schematic plan view of a preferred form of the drain water receiver.

FIG. 4 is a partial fragmentary view of a schematic isometric view of a preferred form of the drain water receiver.

FIG. 5 is a flow diagram showing a preferred method of operating the invention in relationship to FIG. 1, FIG. 2, and FIG. 3.

FIG. 6 is a flow diagram showing a preferred method of operating the invention.

### DETAILED DESCRIPTION

The invention as illustrated can receive drain water through inlet port 3 from a warewasher (not shown) or other greywater producer and store the drain water in the receiving tank 2 for transfer to another source requiring grey water or heat energy or both. For example, the greywater may be used for a scrapping trough (not shown), which feed into a garbage disposer, pulper, scraper accumulator or other device (none of which are shown) for reuse. Reusing the water and heat energy conserves water, heat energy, and reduces the total output to the sewer lines. This results in a huge savings per year in a large commercial kitchen and substantial savings in any other commercial kitchens. This is illustrative of one manner in which the invention may be implemented. It being understood that the drain water receiver 1 can be used with many types of greywater generating systems/devices for reuse in many different ways, not just in the commercial kitchen setting. The terms drain water and greywater are used interchangeably. One purpose of the invention is to facilitate the reuse of greywater. Greywater from commercial kitchens is often referred to as drain water. The drain water receiver addresses the unique capacity and adaptation issues relevant to commercial kitchens, which vary in size and design.

The drain water receiver 1, as illustrated comprises a receiving tank 2 that is configurable and scalable to uniquely fit in a wide variety of commercial kitchens or other settings and functions to transfer greywater to another source for reuse. The component parts of the drain water receiver 1, as illustrated and described below are configurable to accommodate many different design requirements. While it is preferable to scale and configure the drain water receiver to have a low-profile such that it fits underneath a greywater generating system/device, it could be configured and scaled to fit above it, next to it or in a remote location. These configurations, however, would likely be less useful. The receiving tank 1, in its preferred form is a unibody structure made of fabricated heavy-gauge stainless steel body. The receiving tank 2 can be flexible in size to accommodate catchment capacity, flow requirements, pump rates or to configure to a system. The receiving tank 2 could conceivable be constructed with a framed structure or other type of structure or from a variety of materials as long as it maintains its function of effectively receiving and holding drain water.

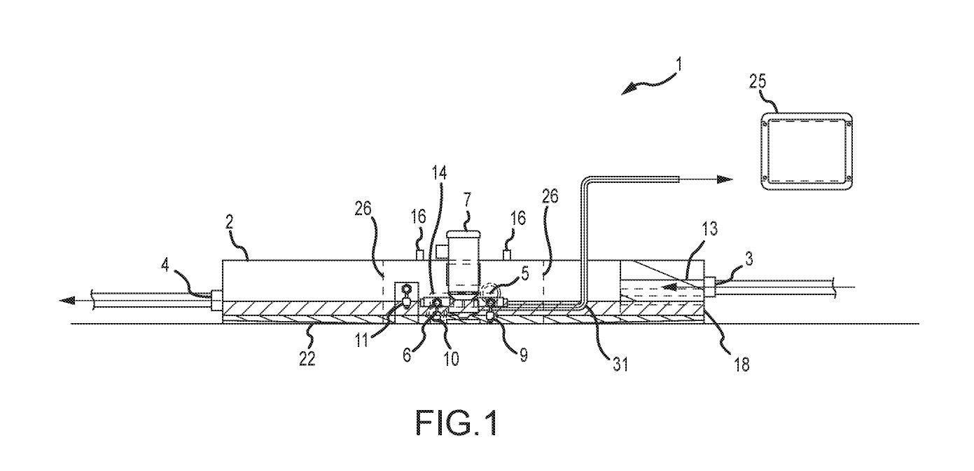

While receiving drain water by gravity feed is preferred, the receiving tank 2 could receive it by other means. The drain water, for example, could be delivered into the receiving tank 2 by pump or manually. The drain water is received through an inlet port 3 mounted to the receiving tank 2. In FIG. 1, the inlet port 3 is mounted to the right wall 18 of the receiving tank 2. The configuration of the inlet port 3 relative to the receiving tank 2 can be adjusted to optimally receive drain water from a greywater generating system. Commercial kitchens are each designed uniquely and contain greywater generators varying in brand, type, or model. Thus, the configurability of the drainwater receiver 1 is essential for meeting the diverse needs of greywater generating devices/systems.

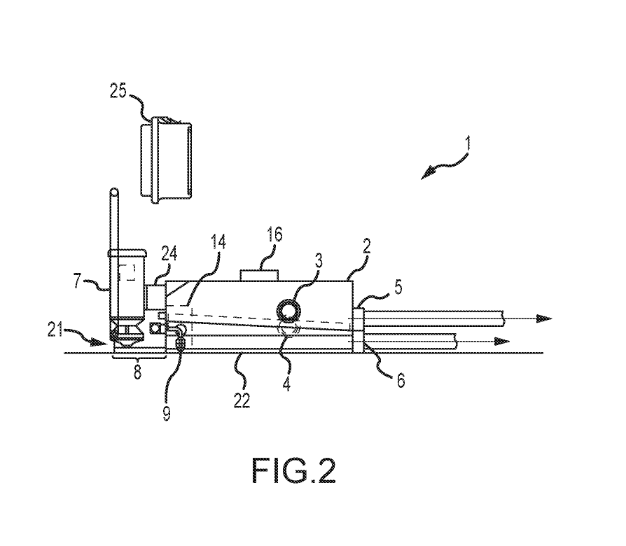

As viewed in FIG. 2, the receiving tank 1 contains one or more overflow ports 4 and 5 being at a height lower than the inlet port 3, that function in conjunction with the inlet port 3 to prevent overflow or back up into a warewasher (not shown) or other greywater generating devices/systems. This is a flow-through (overflow) drain system. The primary overflow port 4 and secondary overflow port 5 are mounted to the receiving tank 2, at heights lower than the inlet port 3. Overflow port 4 and 5 can be configured to different heights, such that as the water level in the receiving tank rises the overflow capacity expands. Preferably each overflow ports 4 and 5 is the same diameter as the inlet port. In one embodiment of the invention, the inlet port 3 is a 2 inch NPT (National Pipe Taper) fitting. The inlet port 3, however, may be different sizes and shapes. When the overflow ports 4 and 5 and inlet port 3 are used in conjunction, overflow ports 4 and 5 provide two times the flow capacity of the inlet port 3. In a preferred embodiment the One benefit of using a primary overflow port 4 and a secondary overflow port 5 is redundancy, if one of the overflow ports 4 or 5 clog, the unobstructed overflow port 4 or 5 is operational. While this is the preferred form of the invention, a drain receiver can be conceived of with one or no overflow ports. If the demands of the system, the drain water flowing into the drain water receiver is less or equal to the grey water being pumped out of the receiving tank 2, the overflow ports 4 and 5 would not be necessary. The invention as illustrated, however, functions optimally with overflow ports.

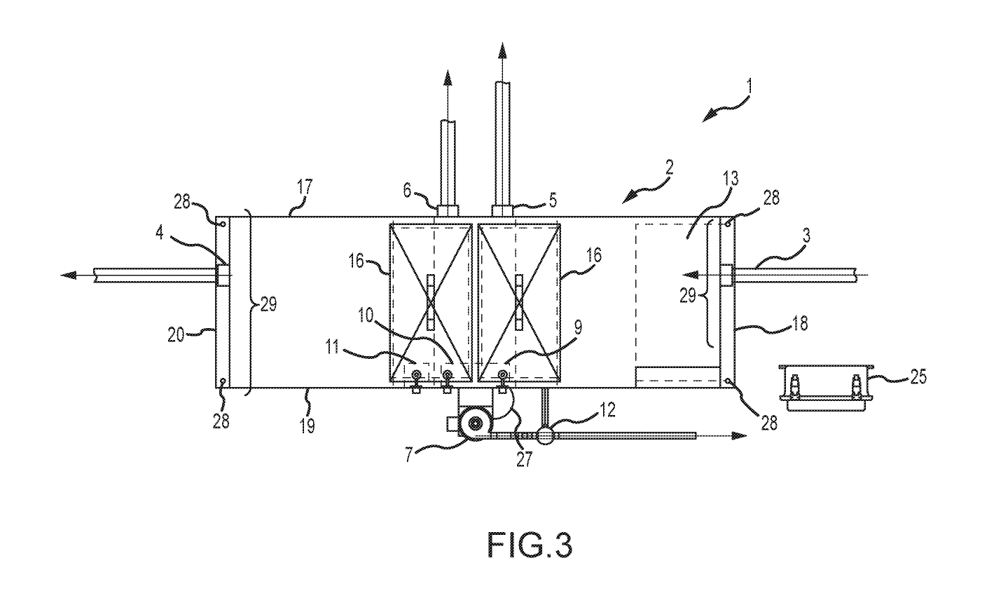

As viewed in FIG. 3, the primary overflow port 4 is mounted to receiving tank 2 on the left wall 20 opposite of inlet port 3 and the secondary overflow port 5 is mounted to the receiving tank on the back wall 17, opposite the pump 7. The overflow ports 4 and 5 are configurable to accommodate the needs of the system. A drain port 6 may be mounted to the receiving tank 2 such that the receiving tank 2 may be completely emptied of drain water for cleaning, moving or storing. The drain port 6 is optimally configured and sized to allow the system to drain efficiently down a standard floor drain. The drain port 6 may be a 2 inch NPT (National Pipe Taper) fitting. The drain port 6, however, may be different sizes and shapes.

FIG. 3 illustrates the drain water receiver's dual-overflow system with twice the drain capacity of any given dish machine. In a preferred embodiment, the over flow port 4 is made of 2″ NPT overflow outlets, which allows the receiving tank 1 to naturally and safely overflow all unused water being received from a dish machine without overflowing onto the floor.

The pump 7 is configured to optimally transfer the drain water out of the receiving tank 2 for reuse. As viewed in FIG. 2, the pump is vertically mounted to the front exterior wall 19 of the receiving tank 2 with a mounting bracket 24. The pump 7 may be of the type produced by Price Pump Co., Model LT25SS-334-21211-33-36-3T7. This model is a high-capacity pump and impeller design with optimum pump curve and pump head variability. The model has variable pumping capacity and variable flow restriction. The pump 7 could be configured in a variety of ways to effectuate the transfer of water from the receiving tank 2 to a location for reuse. For example, the pump 7 may be submersible. A submersible pump addresses the issue of space. Where space is limited, a submersible pump may be placed in the receiving tank 2 in lieu of a pump mounted on the exterior. As shown in FIG. 2, the vertical configuration is a preferred form of the invention because it can operate at minimum water levels. It is conceivable that grey water could be transferred from the receiving tank 1 by gravity feed or even manually for reuse, though this means of transferring grey water may be inefficient. The water in the receiving tank 2 may be pumped for reuse.

The pump 7 draws the grey water from the receiving tank 2 via the intake system 8. The pump 7 is configured to vertically couple with the intake system 8 that allows the pump 7 to operate at minimal water levels. The base of the receiving tank 2 may be sloped, such that there is a flat spot along the midline of the receiving tank 2 base. This allows that drain water to gravity feed to a low spot in receiving tank 2 base. The pump 7 is configured to allow the lowest possible pump face 21 mounting location. As shown in FIG. 2, the intake system 8 is mounted to the receiving tank 2, the intake system base is flush with the receiving tank base 22, and at a height that optimally allows drain water from the receiving tank 2 to fill the intake system 8 and prevent cavitation of the pump 7. The intake system 8 could be configured in a variety of ways to optimally prevent cavitation of the pump 7 at low levels. For example, the intake system 8 could be configured at a height lower than the receiving tank base 22. The intake system 8 includes a rectangular manifold constructed out of sheet metal (though it may be constructed out of any other water tight material), with an opening plumbed to the receiving tank 2. The pump 7 is plumbed to the manifold with a NPT fitting female nipple to connect the pump 7 with the manifold.

The liquid level sensing device 9 is mounted to the interior of the receiving tank 2 to sense the water level. The liquid level sensing device 9 communicates with the pump 7 to power on and off the pump 7 at certain water levels. It is preferred that the liquid level sensing device 9 communicates with the pump 7 to power off when the water level is too low and pump cavitation is probable and to power on when the water is at a minimum level where cavitation will not occur. The liquid level sensing devices 10 and 11 may additionally be mounted to the interior of the receiving tank. These additional sensors are used to communicate with certain greywater generating devices/systems to provide a high water and low water data set to indicate the bandwidth of greywater available in the receiving tank 2.

The receiving tank 2 in its preferred form is sloped such that the all of the water in the receiving tank 2 gravity flows to the lowest point of the receiving tank base 22. The intake system 8 and the drain port 6 are located at the lowest points in the receiving tank 2 for optimal flow of drain water out of the receiving tank 2. This allows the pump 7 to operated effectively at low water levels. Where the receiving tank 2 is sloped, the liquid level sensing devices 9, 10, and 11 may be mounted near the lowest point of the receiving tank base 22 for optimal sensing. Using multiple liquid level sensing devices, though not necessary, allows monitoring the variety of water levels in the receiving tank 2 and certain greywater receiving devices to function optimally in response to the water level data.

It is known that pumps have shorter lifespans when turned on and off frequently. For optimal pump life a system may be implement to prevent frequent powering on and off of the pump 7. A bypass system may be implemented to prolong the life of the pump. As shown in FIG. 3, a bypass system comprises of a return line 27 plumbed from the pump 7 to the receiving tank 2. The return line 27 is sized optimally such that the pump runs at a minimum continuous stable flow when there is no demand for the drain water stored in the receiving tank 2. In another version of a bypass system, a three-way valve system 12 can solve the pump longevity problem, by maintaining continuous operation of the pump 7. When drainwater is not being drawn from the receiving tank 2 for reuse, the three-way valve system 12 will pump the drain water in a circular route to and from the receiving tank 2. The three-way valve system 12 is preferably a three-way solenoid valve plumbed to the exterior of the receiving tank, pump 7 and to a location where greywater is needed for reuse. Since the pump is running continuously, the three-way valve system 12 allows on demand drain water from the receiving tank 2 for reuse. Through a bypass system 27 or 12 is a preferred form of the invention, the drain water receiver 1, as illustrated can operate without it. The operation, however, will likely not be optimal.

The pump 7 may be turned on and off manually. In the preferred embodiment, the pump is monitored and operated via an external control system 25, as shown in FIG. 3. The control system 25 could be hardwired to the pump 7 or it could receive and send information via a wireless option, for example bluetooth, radio, WiFi or other means. The control system 25 could be mounted near the drainwater receiver 3 or it could be a handheld device such as an iphone or android or other means for receiving and sending data. The control system 25 may be conveniently located for an operator to remotely operate the pump 7. The control system 25 could also be used to collect and send information from or to any type of sensor used in conjunction with the drain water receiver 1. For example, the control system 25 could receive information from the water level sensors 9, 10 and/or 11. In one embodiment, there is a means for automatically powering on and off of pump 7 based on data from one or more water level sensors 9, 10, or 11. In another form of the invention, the data from water level sensor 9 signals an operator when the drain water receiver is ready for operation. The signal could be a green light on a control panel that lights up when the receiving tank 2 contains enough drain water for efficient operation.

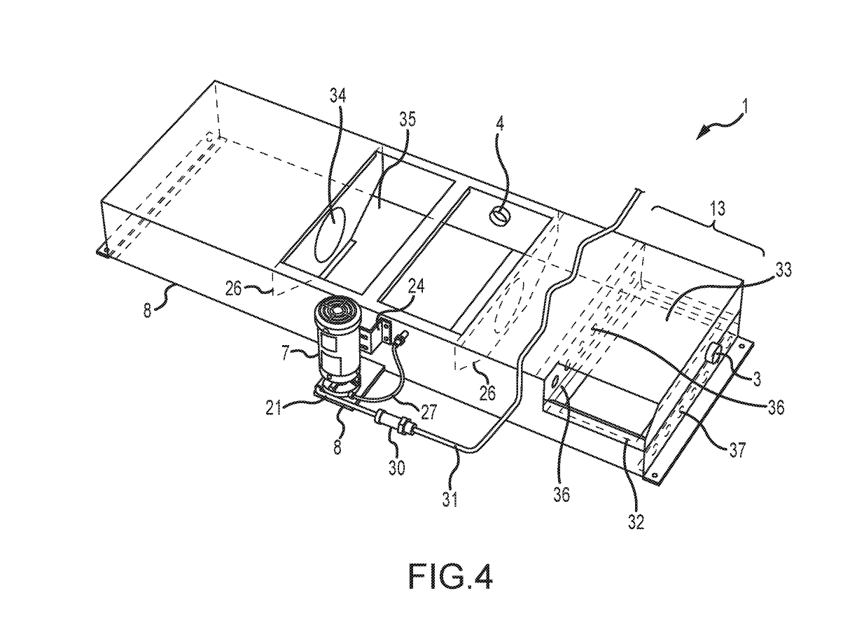

Often drain water contains solid particles large enough to clog the pump 7. If the drain water receiver 1, as illustrated is used in an environment where the incoming drain water contains solid particles, the drain water receiver 1 must contain a filtering system. A filtering system is necessary for use in a commercial kitchen setting, because the grey water contains food and other solid particles. As shown in FIG. 1, incoming drain water is filtered by a primary screened box 13, located within the receiving tank 2 that functions to pre-screen drain water entering the inlet port 3. As shown in FIG. 4, the primary screened box 13 in its preferred form consists of a diffuser box 32, a readily-removable screen 33 and cutout openings 36. The diffuser box 32 may function as a structural element, a water diffuser and/or a screen holder. The diffuser box 32 may be ergonomically angled such that removal of the readily-removable screen 33 is easy for operators. The removal of the readily removable screen 33 allows for removing particulate matter from the screen and cleaning of the inside of the receiving tank 2. The cutout openings 36 if used function to decrease weight of the drainwater receiver 1, allow cleaning of the inside of the receiving tank 2, and act as overflow protection. Additional cutout openings 37 may be placed below the primary screened boxed 33 to address design and weight issues. A secondary screened box 14 situated on the internal front wall 16 of the receiving tank 2 is used as a second line of defense against particulate matter clogging the pump 7 and halting operations. The secondary screened box 14 is located such that all water entering the intake system 8 or pump 7 is filtered subsequent to the primary filtering at primary screened box 13. In the preferred embodiment, the primary screened box 13 is made of stainless steel and the filter holes are between 1/16-⅛ inches. The secondary screened box 14, in its preferred form is made of stainless steel and the filter holes are 1/16-⅛ inch. The secondary screened box 14 is not fully welded to the receiving tank base 22 allowing water to seep under the secondary screened box 14. This allows water at the base of the receiving tank 2 to fill the intake system 8. Thus, the pump 7 can run at minimum water levels. The preferred form of the pump 7 is oversized relative to the type of greywater entering the drain water receiver 1, such that it can operate in the event that solid particles contained in the greywater enter the pump. The screen holes should be sized to optimally protect the pump 7. Thus, the screen holes are sized based on the pump 7 specifications. The screens may be made out of any material such as plastic, composite or other material suitable for filtering particles out of water.

The drain water receiver 1 may be used to capture and transfer heat energy. In scullery operations the drain water receiver 1 may be used to temper drain water entering the receiving tank 2. There are a variety of methods for tempering drain water that is 140° F. (60° C.) or higher when utilizing a drain water receiver 1 for this function. The drain water may be mixed with cooler drain water that is also entering the receiving tank 2. A heat exchanger (not shown) may be used with the drain water receiver 1 to capture heat energy for use elsewhere. These examples of tempering drain water are illustrative and not exhaustive. Heat exchangers (not shown) may also be used to capture cold energy from the drain water in the receiving tank 2. The function of capturing and transferring heat energy is an optional feature of the drain water receiver 1.

As shown in FIG. 3, the drain water receiver 1 in its preferable form contains two doors 16. The doors are scalable and configurable to meet the design of the greywater generator device/system. The drain water receiver 1 could be conceived of without any doors. A door or doors, however, make cleaning, inspection and maintenance easier. The doors 16 do not need to be placed in the middle of the receiving tank 2, as shown they may be configured to function optimally within each unique operation. The drain water receiver 1, as illustrated may contain a structural component to provide support to the receiving tank 2. As shown in FIG. 4, the two baffling/supports 26 are ideally located to provide support where the doors, pump and secondary screened box are located. The baffling/supports 26 have the added benefit of preventing sloshing and allowing for easy maintenance and cleaning. The baffling/supports may contain openings 35 and 34 to allow for cleaning of the receiving tank 2 and to allow for water flow through the receiving tank 2.

As shown in FIG. 3, the drain water receiver 1 may contain feet 29 and anchoring points 28 for further support and seismic compliance. Though this feature is desirable it is not necessary to the invention.

### An Illustrative Method of Operating a Drain Water Receiver

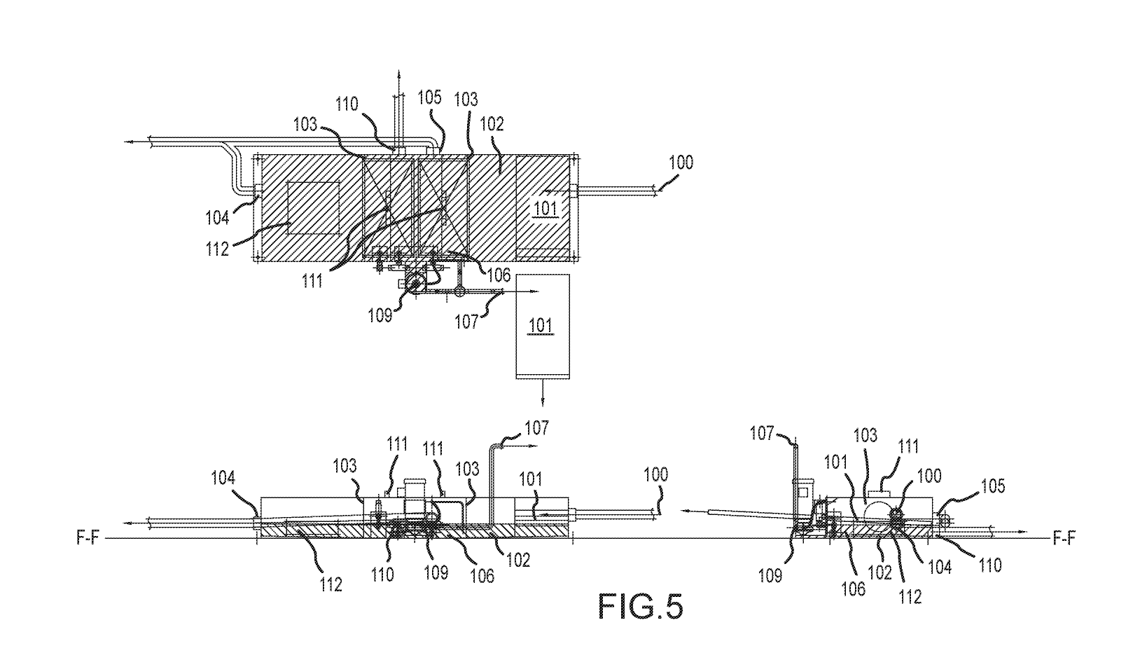

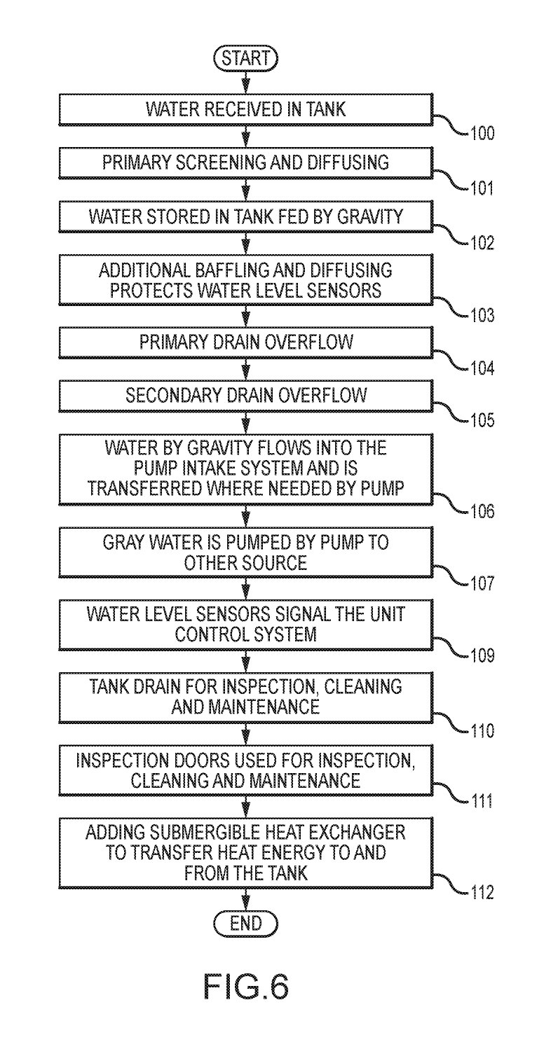

The operation of the drain water receiver 1, is best illustrated in FIG. 5 and FIG. 6. In step 100, the drain water is received from an outside source and enters through the inlet port 3 to the primary screened box 13. In the preferred method, the drain water is gravity fed into the receiving tank 2. In step 101, any particles that may clog the pump 7 are filtered through a primary screened box 13. In step 101, turbulent drain water is diffused as it enters the receiving tank 2 via the primary screened box 13.

In step 102, the water is optionally stored in the receiving tank 2.

In step 103, as the water flows to the lowest point in the tank situated near the pump 7 and along the midline of the receiving tank, it flows through additional baffling/support 26 to reduce sloshing. This step is designed to protect the water level sensors 9, 10, or 11. A reduction in water turbulence or sloshing could conceivably be accomplished by other means.

In step 104, when the water entering the tank has reached a level where the water level is too high, excess water is gravity fed out of overflow port 4. If the water continues to rise regardless of step 104, or when step 104 is not implemented, step 105 will occur naturally. In step 105, the excess water gravity feeds through the overflow port 5. In steps, 104 and 105 the overflow water may be disposed of down the drain. Though two overflow ports are not necessary, this is a preferred method of operation.

In step 106, water gravity flows into the intake system 8 and is transferred by the pump 7 out of the receiving tank 2 based on the water level. Prior to entering the intake system 8, the water may be filtered by the secondary screened box 14. If there is no external demand for grey water, the pump may continue to operate feeding water in a circular path through a three-way acting valve 12, or in the alternative, through a return line 27, though not necessary, the longevity of the pump 7 depends on this step. The water level sensors 10 and 11 may be used in step 106 for acquiring information about the water level and providing data to a receiving device for optimal operation.

In step 107, grey water is pumped by pump 7 to another source. The pump may be activated in a number of ways including but not limited to manually, remotely by bluetooth, radio, WiFi, hardwired controls or any other means capable of signalling the pump to activate.

As an alternative to step 107, step 109 is implemented, the water level sensor 9, signals to the pump 7 to power on and off based on the water level in the receiving tank 2. In the alternative, the water level sensor 9 may signal a ready to operator indicator, such that the operator knows when to power pump 7 on and off.

In step 110, the water in the receiving tank 2 is disposed of via drain port 6 for inspection, cleaning and maintenance of the drainwater receiver 1.

In step 111, where the invention contains doors 16, they are removed for inspection, cleaning and maintenance of the drainwater receiver 1.

In step 112, heat energy is captured and transferred in an out of the drain water contained in the receiving tank 2 by submersible heat exchange coils or other means for transferring heat energy.

The invention claimed is:

1. a drain water receiver comprising
a receiving tank;
an inlet port integral to the upper portion the receiving tank through which drain water enters the receiving tank;
an overflow port, fluidly coupled to the inlet port, integral to the receiving tank at a position vertically lower than the centerline of the inlet port for discharging excess drain water whereby preventing drain water from exiting through the inlet port;
a pump vertically oriented for distributing drain water from the receiving tank to an outside source for reuse;
an intake system is plumbed to the receiving tank at the receiving tank's lowest point, whereby drain water from the receiving tank gravity flows into the intake system, the centerline of the intake system is lower than the centerline of the overflow port, the pump is mounted to the intake system at substantially a right angle;
a primary filter having a screen and a support within the receiving tank, attached to the receiving tank whereby solids of a specified size entering the inlet port are captured and the drain water diffused, the screen location is higher than the overflow port centerline and lower than the inlet port centerline;
a drain port integral to the receiving tank whereby drain water is evacuated from the receiving tank for emptying or cleaning the drain water receiver, the centerline of the drain port is lower than the centerline of the overflow port.

2. The drain water receiver of claim 1, further comprising a secondary filter having a screen within the receiving tank for capturing particles that escaped the primary filter, acting as a slosh shield, and diffusing the drain water, the primary filter is located between the inlet port and the secondary filter, and the secondary filter is located between the primary filter and the intake.

3. The drain water receiver of claim 2, wherein the secondary filter is a cage screen within the receiving tank acting as a secondary filter near the intake.

4. The drain water receiver of claim 2, wherein the secondary filter further comprises a wall that sits nearly flush with the receiving tank base but is not affixed to the base whereby drain water enters that intake at low water levels and acts as a slosh shield to prevent false liquid level readings.

5. The drain water receiver of claim 2, wherein the secondary filter comprises a plurality of filter holes sized to prevent solids that are detrimental to the pump from entering the pump.

6. The drain water receiver of claim 1, wherein the tank is configurable as to dimension.

7. The drain water receiver of claim 1, wherein the inlet port, the overflow port and the drain port are configurable on the vertical axis and horizontal axis of the drain water receiver, so long as the centerline of the overflow port is lower than the centerline of the inlet port and the centerline of the drain port is lower than the centerline of the overflow port.

8. The drain water receiver of claim 1, wherein drain water is gravity fed into the inlet port.

9. The drain water receiver of claim 1, further comprising a liquid level sensing device configured to turn the pump on an off at specified liquid levels.

10. The drain water receiver of claim 1, further comprising two or more liquid level sensing devices to provide a high water and low water data set to indicate the bandwidth of greywater available in the receiving tank.

11. The drain water receiver of claim 1, further comprising a bypass system meaning a return line plumbed from the receiving tank to the pump wherein the return line is optimized such that the pump runs at a minimum continuous stable flow prolonging the life of the pump.

12. The drain water receiver of claim 1, further comprising a bypass system meaning a three-way valve system allowing for on demand drain water from the receiving tank.

13. The drain water receiver of claim 1, further comprising an external control system wherein the pump is controlled remotely by either a panel hardwired to the pump or wirelessly with a digital device.

14. The drain water receiver of claim 1, wherein the primary filter screen has an angle between approximately parallel to approximately 45 degrees relative to the receiving tank base.

15. The drain water receiver of claim 14, wherein the receiving tank further comprises an opening for readily removing the primary filter screen at its highest point on the vertical axis for cleaning.

16. The drain water receiver of claim 14 wherein the primary screen having a plurality of filter holes to capture particulate matter and optimize drain flow.

17. The drain water receiver of claim 14 wherein primary filter support further comprises a vertical support.

18. The drain water receiver of claim 14 wherein the vertical support has a top, a bottom, and a wall, the vertical support is substantially z shaped, the top is substantially at a right angle to the wall, the bottom is substantially at a right angle to the wall, the top extends along the horizontal axis in the opposite direction that the bottom extends, the wall has perforations or cutout openings across its face, the top face is seamed the top interior of the receiving tank, the bottom is a support for the primary filter screen.

19. The drain water receiver of claim 1, wherein the base of the receiving tank is sloped such that the lowest point of the receiving tank is substantially at the midline.

20. The drain water receiver of claim 1, further comprising a heat exchanger within the receiving tank for either capturing cold energy or heat energy from drain water in the receiving tank.

21. The drain water receiver of claim 1, further comprising a cleaning port.

22. The drain water receiver of claim 21, wherein the cleaning port comprises a removable door located at the top of the receiving tank.

23. The drain water receiver of claim 1, wherein the receiving tank further comprises baffling for supporting for the tank and the cleaning ports and diffusing incoming drain water, and acting as a slosh guard, the baffling having openings for cleaning, and water flow.

24. The drain water receiver of claim 1, wherein the receiving tank further comprises feet and anchoring points.

25. The drain water receiver of claim 1, wherein drain water receiver is substantially stainless steel.

26. The drain water receiver of claim 1, wherein the inlet port, the overflow port and the drain port are 2 inch NPT fittings.

27. A drain water receiver comprising a receiving tank having a base sloped such that the lowest point of the receiving tank is substantially at the midline;
an inlet port integral to the upper portion the receiving tank through which drain water enters the receiving tank;
an overflow port, fluidly coupled to the inlet port, integral to the receiving tank at a position vertically lower than the centerline of the inlet port for discharging excess drain water whereby preventing drain water from exiting through the inlet port;
a pump vertically oriented for distributing drain water from the receiving tank to an outside source for reuse;
an intake system having a manifold plumbed to the receiving tank at the receiving tank's lowest point, whereby drain water from the receiving tank gravity flows into the intake system, the centerline of the intake system is lower than the centerline of the overflow port, the pump is mounted to the intake system at substantially a right angle;
a primary filter having a screen, a vertical support and a horizontal support, the screen having a plurality of filter holes to capture particulate matter and optimize drain flow, the vertical support and the horizontal support within the receiving tank and attached to the receiving tank for holding the screen, the screen location is higher than the overflow port centerline and lower than the inlet port centerline, the primary filter screen has an angle between approximately parallel to approximately 45 degrees relative to the receiving tank base;
an opening for readily removing the primary filter screen at its highest point on the vertical axis for cleaning;
a secondary filter having a cage screen within the receiving tank for capturing particles that escaped the primary filter, acting as a slosh shield to prevent false liquid level readings, and diffusing the drain water, the cage screen having a plurality of filter holes sized to prevent solids detrimental to the pump from entering the pump, the base of the cage screen sits nearly flush with the interior of the receiving tank base but not affixed whereby low levels of drain water enter the intake, the primary filter is located between the inlet port and the secondary filter, and the secondary filter is located between the primary filter and the intake;
a drain port integral to the receiving tank whereby drain water is evacuated from the receiving tank for emptying or cleaning the drain water receiver, the centerline of the drain port is lower than the centerline of the overflow port;
a control system having a liquid level sensing devices for communicating the drain water level in the receiving tank, to a control for powering on and off the pump, the liquid level sensors are located between the intake system and the secondary filter;
a cleaning port having readily removable doors located at the top of the receiving tank;
a baffling support affixed to the inside of the receiving tank on either sides of the cleaning port, with cutout openings at the base for water flow, and center cutout openings for access to the tank for cleaning, the baffling diffuses incoming drain water, and acts as a slosh guard.

28. The drain water receiver of claim 27, wherein the tank is configurable as to dimension.

29. The drain water receiver of claim 27, wherein the inlet port, the overflow port and the drain port are configurable on the vertical axis and horizontal axis of the drain water receiver, so long as the centerline of the overflow port is lower than the centerline of the inlet port and the centerline of the drain port is lower than the centerline of the overflow port.

30. The drain water receiver of claim 27, wherein drain water is gravity fed into the inlet port

31. The drain water receiver of claim 27, further comprising two or more liquid level sensing devices to provide a high water and low water data set to indicate the bandwidth of greywater available in the receiving tank.

32. The drain water receiver of claim 27, further comprising a bypass system meaning a return line plumbed from the receiving tank to the pump wherein the return line is optimized such that the pump runs at a minimum continuous stable flow prolonging the life of the pump.

33. The drain water receiver of claim 27, further comprising a bypass system meaning a three-way valve system allowing for on demand drain water from the receiving tank.

34. The drain water receiver of claim 27, further comprising an external control system wherein the pump is controlled remotely by either a panel hardwired to the pump or wirelessly with a digital device.

35. The drain water receiver of claim 27, further comprising a heat exchanger within the receiving tank for either capturing cold energy or heat energy from drain water in the receiving tank.

36. The drain water receiver of claim 27, wherein the receiving tank further comprises feet and anchoring points.

37. The drain water receiver of claim 27, wherein drain water receiver is substantially stainless steel.

38. The drain water receiver of claim 27, wherein the inlet port, the overflow port and the drain port are 2 inch NPT fittings.

39. The drain water receiver of claim 27 wherein the vertical support of the primary screen has a top, a bottom, and a wall, the vertical support is substantially z shaped, the top is substantially at a right angle to the wall, the bottom is substantially at a right angle to the wall, the top extends along the horizontal axis in the opposite direction that the bottom extends, the wall has perforations or cutout openings across its face, the top face is seamed to the top interior of the receiving tank, the bottom is a support for the primary filter screen.

40. A method of operating a drain water receiver, which comprises
first, receiving drain water in a receiving tank;
second, filtering and diffusing drain water received through an inlet port;
third, capturing drain water in the receiving tank;
forth, gravity feeding water through a secondary filter/diffuser;
fifth, gravity feeding drain water to an intake;
sixth, pumping drain water from the intake through a bypass system or to another system for reuse.

41. A method as in claim 40, further comprising
expelling drain water captured in the receiving tank through an overflow port;
emptying drain water captured in the receiving tank through the drain port.

42. A method as in claim 40, further comprising
extracting or adding heat energy from drain water captured in the receiving tank;
with submerged heat exchangers.

43. A method as in claim 40, further comprising
sensing the water level;
transmitting the water level data to the pump;
activating or deactivating the pump based on water level data.

44. A method as in claim 40, further comprising
removing the cleaning port doors;
cleaning the interior of the drain water receiver manually.
